(19) United States
(12) Patent Application Publication
(10) Pub. No.: US 2023/0233984 A1
(43) Pub. Date: Jul. 27, 2023

(54) SORBENT ARTICLE WITH WATER EXCLUSIONARY PROPERTIES AND METHODS OF FORMING THE SAME

(71) Applicant: W. L. Gore & Associates, Inc., Newark, DE (US)

(72) Inventors: Edward H. Cully, Newark, DE (US); Christine M. Scotti, Newark, DE (US)

(21) Appl. No.: 18/101,736

(22) Filed: Jan. 26, 2023

Related U.S. Application Data
(60) Provisional application No. 63/303,688, filed on Jan. 27, 2022.

(51) Int. Cl. B01D 53/04; B33Y 80/00

(52) U.S. Cl. CPC B01D 53/0462; B33Y 80/00; B01D 53/0407; B01D 2257/504

(57) ABSTRACT

A sorbent article is described including a plurality of sorbent elements structured to adsorb and desorb CO₂ and a plurality of hydrophobic elements mixed with the plurality of sorbent elements and structured to exert hydrophobic force to expel liquid water from the sorbent article. Also described herein are methods of forming such sorbent articles for the purpose of swing adsorption, including for direct air capture (DAC) of carbon dioxide.

### CROSS-REFERENCE TO RELATED APPLICATION

This application claims the benefit of U.S. Provisional Application No. 63/303,688, filed Jan. 27, 2022, which is incorporated herein by reference in its entirety for all purposes.

### FIELD

The present disclosure relates generally to apparatuses, systems, and methods pertaining to sorbent articles. More specifically, the disclosure relates to sorbent articles and methods of using the sorbent articles for the purpose of swing adsorption.

### BACKGROUND

Increasing carbon dioxide (CO₂) levels associated with greenhouse emissions are shown to be harmful to the environment. As reported by the Climate.gov article “Climate Change: Atmospheric Carbon Dioxide,” the 2019 average carbon dioxide level in the atmosphere was 409.8 ppm, the highest level that has been noted in the past 800,000 years. The rate of increase of CO₂ in the atmosphere is also much higher than the rates in previous decades.

In order to limit the impact of climate change, it is not only necessary to reduce CO₂ emissions in the near future to zero but also to achieve negative CO₂ emissions. Several possibilities exist in order to achieve negative emissions, e.g. combustion of biomaterials for the generation of electricity combined with CO₂ capture from the combustion of flue gas and subsequent CO₂ sequestration (“BECCS”) or direct air capture (“DAC”) of CO₂.

Gas separation by adsorption has many different applications in industry, for example removing a specific component from a gas stream, where the desired product can either be the component removed from the stream, the remaining depleted stream, or both. Thereby, both trace components as well as major components of the gas stream can be targeted by the adsorption process. One important gas separation application is in capturing CO₂ from gas streams, e.g., from flue gases, exhaust gases, industrial waste gases, biogas or atmospheric air. Atmospheric air is considered a dilute feed stream of CO₂.

Capturing CO₂ directly from the atmosphere, referred to as DAC, is one of several means of mitigating anthropogenic greenhouse gas emissions and has attractive economic prospects as a non-fossil, location-independent CO₂ source for the commodity market and for the production of synthetic fuels. The specific advantages of CO₂ capture from the atmosphere include: a) DAC can address the emissions of distributed sources (e.g. vehicles . . . land, sea and air), which account for a large portion of the worldwide greenhouse gas emissions and can currently not be captured at the site of emission in an economically feasible way; b) DAC can address legacy emissions and can therefore create truly negative emissions, and c) DAC systems do not need to be attached to the source of emission but may be location independent and can be located at the site of further CO₂ processing or usage.

### SUMMARY

A sorbent article is described including a plurality of sorbent elements structured to adsorb and desorb CO₂ and a plurality of hydrophobic elements mixed with the plurality of sorbent elements and structured to exert hydrophobic force to expel liquid water from the sorbent article. Also described herein are methods of forming such sorbent articles, such as for the purpose of swing adsorption, including for direct air capture (DAC) of carbon dioxide, for example.

According to one example (“Example 1”), a sorbent article includes a plurality of sorbent elements structured to adsorb and desorb CO₂ and a plurality of hydrophobic elements mixed with the plurality of sorbent elements and structured to exert hydrophobic force to expel liquid water from the sorbent article.

According to another example (“Example 2”) further to Example 1, the sorbent article further includes a container in which the plurality of sorbent elements and the plurality of hydrophobic elements are maintained in an intermixed distribution.

According to another example (“Example 3”) further to Example 2, the container includes a drain through which the liquid water is expelled from the sorbent article.

According to another example (“Example 4”) further to Example 2 or 3, the sorbent elements are discrete and loosely packed within the container, and the hydrophobic elements are discrete and loosely packed within the container.

According to another example (“Example 5”) further to any preceding Example, the hydrophobic elements form a three-dimensional network of hydrophobic elements.

According to another example (“Example 6”) further to Example 5, the network of hydrophobic elements defines a plurality of interstitial spaces within the network of hydrophobic elements and at least some of the sorbent elements are disposed within the interstitial spaces defined by the network of hydrophobic elements.

According to another example (“Example 7”) further to Example 5 or 6, the network of hydrophobic elements is entrained in a structure having a plurality of hydrophobic nodes and fibrils.

According to another example (“Example 8”) further to Example 7 and further to Example 2, the structure is at least partially contained within the container and is structured to facilitate restricting movement of the hydrophobic elements with respect to the sorbent elements to maintain the intermixed distribution of the plurality of sorbent elements and the plurality of hydrophobic elements.

According to another example (“Example 9”) further to any preceding Example, the sorbent article includes at least one hydrophobic layer disposed adjacent to the sorbent elements and the hydrophobic elements.

According to another example (“Example 10”) further to Example 9, the sorbent article includes two porous hydrophobic layers such that the sorbent elements and the hydrophobic elements are disposed between the two porous hydrophobic layers.

According to another example (“Example 11”) further to Example 8 or 9, the hydrophobic layer has a first permeability with respect to water vapor that is greater than a second permeability with respect to liquid water, wherein the liquid water is formed as result of condensation of the water vapor within the sorbent article.

According to another example (“Example 12”) further to Example 11, the second permeability is defined such that the hydrophobic layer is impermeable with respect to the liquid water under atmospheric pressure.

According to another example (“Example 13”) further to any one of Examples 9-12, the hydrophobic elements are configured to exert sufficient hydrophobic force to expel the liquid water through the hydrophobic layer.

According to another example (“Example 14”) further to any preceding Example, the hydrophobic elements are configured to exert the hydrophobic force against liquid water located on a surface of the sorbent article to facilitate reducing an amount of liquid water entering the sorbent article.

According to another example (“Example 15”) further to any preceding Example, the hydrophobic elements are a first plurality of hydrophobic elements having a first hydrophobicity, the sorbent article further comprising a second plurality of hydrophobic elements of a material different from the first plurality of hydrophobic elements characterized by a second hydrophobicity that is different from the first hydrophobicity.

According to another example (“Example 16”) further to Example 15, the second plurality of hydrophobic elements are different in size or shape from the first plurality of hydrophobic elements.

According to another example (“Example 17”) further to Example 15 or 16 and further to Example 6, the second plurality of hydrophobic elements are disposed within the interstitial spaces defined by the network of hydrophobic elements.

According to another example (“Example 18”) further to any preceding Example, the plurality of hydrophobic elements contribute to between approximately 30% and 70% of a density of the sorbent article.

According to another example (“Example 19”), a method of forming a sorbent article includes providing a plurality of sorbent elements configured to adsorb and desorb a substance, providing a plurality of hydrophobic elements, and combining the sorbent elements and the hydrophobic elements to form a sorbent article such that the hydrophobic elements are configured to exert hydrophobic force to expel liquid water from the sorbent article.

According to another example (“Example 20”) further to Example 19, the method further includes enclosing the plurality of sorbent elements and the plurality of hydrophobic elements in a container such that the sorbent elements and the hydrophobic elements are maintained in an intermixed distribution.

According to another example (“Example 21”) further to Example 20, the container is structured to facilitate restricting movement of the hydrophobic elements with respect to the sorbent elements to maintain the intermixed distribution thereof.

According to another example (“Example 22”) further to any one of Examples 19-21, the hydrophobic elements form a network of hydrophobic elements.

According to another example (“Example 23”) further to Example 22, the network of hydrophobic elements defines a plurality of interstitial spaces within the network of hydrophobic elements. The method further includes combining the sorbent elements and the hydrophobic elements such that the sorbent elements are disposed within the interstitial spaces defined by the network of hydrophobic elements.

According to another example (“Example 24”) further to any one of Examples 19-23, the method further includes disposing at least one porous hydrophobic layer adjacent to the sorbent elements and the hydrophobic elements.

According to another example (“Example 25”) further to any one of Examples 19-24, the plurality of hydrophobic elements are a first plurality of hydrophobic elements having a first hydrophobicity. The method further includes combining a second plurality of hydrophobic elements with the sorbent elements and the first plurality of hydrophobic elements, the second plurality of hydrophobic elements having a material different from the first plurality of hydrophobic elements characterized by a second hydrophobicity that is different from the first hydrophobicity.

According to another example (“Example 26”) further to Example 23, the second plurality of hydrophobic elements are combined with the sorbent elements and the first plurality of hydrophobic elements such that the hydrophobic elements are disposed within the spaces defined by the network of hydrophobic elements.

According to another example (“Example 27”) further to Example 19 or 20, the method further includes forming a drain through which the liquid water is expelled from the container.

According to another example (“Example 28”) further to any one of Examples 19-27, combining the sorbent elements and the hydrophobic elements to form the sorbent article comprises: disposing the sorbent elements and the hydrophobic elements in a predefined placement with respect to each other via 3-D printing.

According to another example (“Example 29”), a sorbent article for removing carbon dioxide gas from an atmosphere is disclosed. The sorbent article may include an enclosure which supports a distribution of sorbent elements intermixed with hydrophobic elements. The enclosure defines an exterior surface of the enclosure and an opposing interior surface facing the distribution. A first portion of the enclosure permits passage of the carbon dioxide gas between the atmosphere and the distribution, and a second portion of the enclosure permits passage of a mass of water between the distribution and the exterior surface of the enclosure. Furthermore, the sorbent elements are capable of adsorbing and desorbing the carbon dioxide gas via the exterior surface of the enclosure with the application of a temperature change to the distribution. The hydrophobic elements define a first hydrophobicity of the hydrophobic elements and the sorbent elements define a second hydrophobicity of the sorbent elements, such that the second hydrophobicity is lesser than the first hydrophobicity. Also, the hydrophobic elements within the distribution are distributed to exert a hydrophobic force on the mass of water within the distribution when the mass of water transitions to a liquid water. The hydrophobic force directing the liquid water to the exterior surface of the enclosure to expel the liquid water from the distribution.

According to another example (“Example 30”) further to Example 29, the hydrophobic elements define a structure having a plurality of hydrophobic fibrils, and the plurality of hydrophobic fibrils form a network which defines a plurality of interstitial spaces between the plurality of hydrophobic fibrils or filaments.

According to another example (“Example 31”) further to Example 30, the sorbent elements are disposed within the interstitial spaces.

According to another example (“Example 32”) further to Example 29, the enclosure is formed by an exterior surface of the distribution.

According to another example (“Example 33”) further to Example 29, the first portion of the enclosure is formed by an exterior surface of the distribution.

According to another example (“Example 34”) further to Example 29, the second portion of the enclosure is formed by an exterior surface of the distribution.

According to another example (“Example 35”) further to Example 29, the enclosure defines a drain through which the liquid water is expelled from the distribution.

According to another example (“Example 36”) further to any one of Examples 29-35, the sorbent elements are discrete and loosely packed within the enclosure, and the hydrophobic elements are discrete and loosely packed within the enclosure.

According to another example (“Example 37”) further to any one of Examples 29-36, the hydrophobic elements are composed of at least one of expanded polytetrafluoroethylene (ePTFE), polytetrafluoroethylene (PTFE), or expanded polyethylene (ePE).

The foregoing Examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is an elevational view of a sorbent material;

FIG. 2A is an elevational view of a hydrophobic material in particle form as disclosed herein;

FIG. 2B is an elevational view of a hydrophobic material in filamentous form as disclosed herein;

FIG. 3 is an elevational view of a sorbent material with hydrophobic particles and filaments in accordance with an embodiment as disclosed herein;

FIG. 4 is an elevational view of a sorbent material system with hydrophobic particles and filaments in accordance with an embodiment as disclosed herein;

FIGS. 5A through 5C are elevational views of a sorbent material during a water exclusion process in accordance with an embodiment as disclosed herein; and

FIG. 6 is a flow chart illustrating a method of making a sorbent material in accordance with an embodiment as disclosed herein.

FIG. 7 is a schematic view of a particle of the sorbent article in accordance with an embodiment as disclosed herein;

FIG. 8 is a schematic view of a filament of the sorbent article in accordance with an embodiment as disclosed herein; and

FIG. 9 is an elevational view of a sorbent material system with a drain in accordance with an embodiment as disclosed herein.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

The term “network” as used herein describes a group or system where individual elements may or may not be connected with one or more individual element. Also, the term “connected” as used herein describes a physical connection, for example tangentially positioning two or more components with respect to each other, temporarily attaching a portion of one component with a portion of another component, or spatially positioning multiple components so as to affect each other or to affect at least one other element via forces (such as hydrophobic forces as described herein), or temporarily or permanently affixing one component to another.

The term “fibril” as used herein describes an elongated piece of material such as a polymer, where the length and width are substantially different from each other. For example, a fibril may resemble a piece of string or fiber, where the width (or thickness) is much shorter or smaller than the length.

The term “node” as used herein describes a connection point of at least two fibrils, where the connection may be defined as a location where the two fibrils come into contact with each other, permanently or temporarily. In some examples, a node may also be used to describe a larger volume of polymer than a fibril and where a fibril originates or terminates with no clear continuation of the same fibril through the node. In some examples, a node has a greater width but a smaller length than the fibril.

As used herein, “nodes” and “fibrils” may be used to describe objects that are usually, but not necessarily, connected or interconnected, and have a microscopic size, for example. A “microscopic” object may be defined as an object with at least one dimension (width, length, or height) that is substantially small such that the object or the detail of the object is not visible to the naked eye or difficult, if not impossible, to observe without the aid of a microscope or some type of magnification device. In some examples, nodes and fibrils may form a micro-network providing interstitial spaces.

As used herein, “particles” and “filaments” may be used to describe objects that may or may not be connected or interconnected, and have a macroscopic size, for example. A “macroscopic” object may be defined as an object whose minimum dimension is substantially large such that the object or the detail of the object is visible to the naked eye. A filament differs from a particle in that a filament has a larger length-to-width ratio, similar to a fibril. A filament and a particle may both contain or consist of a plurality of nodes and fibrils. In some examples, particles and filaments may form a macro-network providing interstitial spaces.

It is to be understood that the difference in size between a node and a particle, or between a fibril and a filament, may be in any suitable magnitude with respect to the smaller of the two objects, so long as the sizes of the object do not deviate from the definitions as described above (that is, whether or not the object is visible to the naked eye). For example, the size of a particle or a filament may be at least approximately 100 times, approximately 500 times, approximately 1000 times, approximately 5000 times, approximately 10,000 times, or any other suitable value or range therebetween, with respect to the size of a node or a fibril, respectively. In some examples, a node or a fibril may have a width of less than about 500 nm (or 0.5 micron), less than about 250 nm, less than about 150 nm, less than about 100 nm, or any other suitable value or range therebetween.

### Description of Various Embodiments

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

The present disclosure relates to a sorbent article, methods of forming a sorbent article, and methods of using a sorbent article to adsorb and separate one or more desired substances from an input. While the sorbent article is described below for use in capture of CO₂ from an air feed stream, it may be used in other adsorbent methods and applications. These methods include, but are not limited to, adsorption of substances from various inputs, including other gas feed streams (e.g., combustion exhaust) and liquid feed streams (e.g., ocean water). The adsorbed substance is not limited to CO₂. Other adsorbed substances may include, but are not limited to, other gas molecules (e.g., N₂, CH₄, and CO), liquid molecules, and solutes. In certain embodiments, the input may be dilute, containing on the order of parts per million (ppm) of the desired substance.

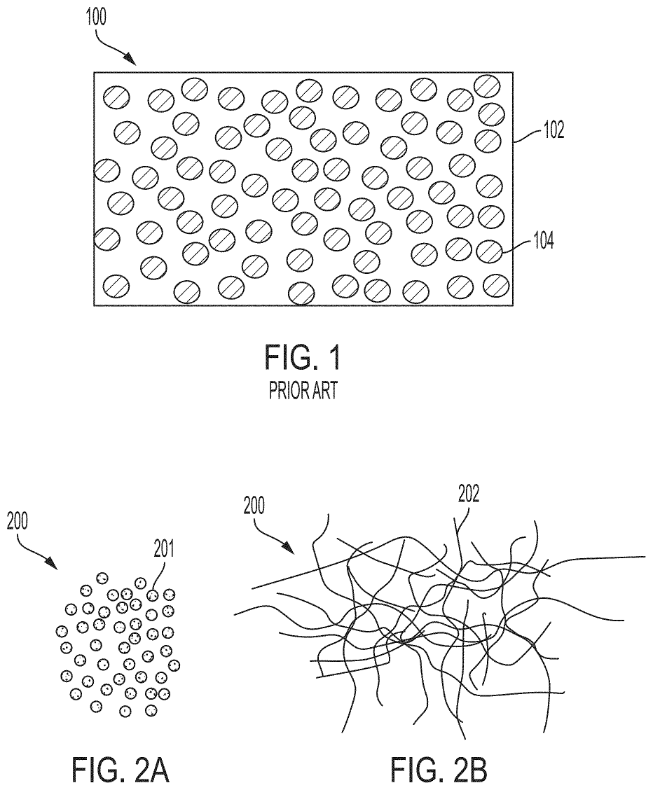

FIG. 1 shows a sorbent article 100 of the prior art. The sorbent article 100, in some examples, may be stored or at least partially confined within an enclosure 102 such as a casing or other type of container. The sorbent article 100 includes a plurality of sorbent elements 104.

FIG. 2A shows exemplary hydrophobic elements 200 that are in the form of particles 201, according to some embodiments, where each particle may be also separate and disconnected from other particles.

FIG. 2B shows exemplary hydrophobic elements 200 that are in the form of filaments 202, according to some embodiments, where each filament may be also separate and disconnected from other filaments

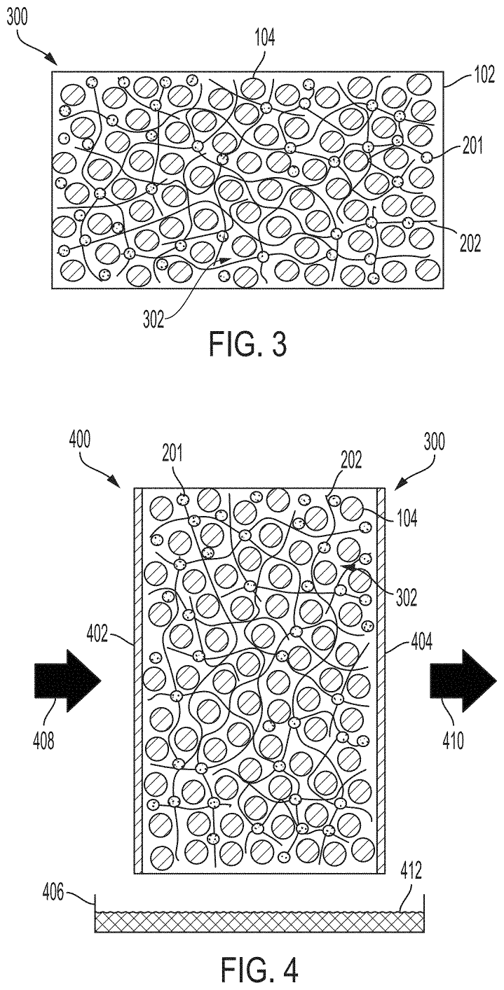

FIG. 3 shows an exemplary sorbent article 300, according to some embodiments, using the hydrophobic elements 200 in the form of both hydrophobic particles 201 and hydrophobic filaments 202. The hydrophobic elements 200 and the sorbent elements 104 are mixed together and structured to exert hydrophobic force to expel liquid water from the sorbent article 300. For example, the hydrophobic particles 201 and the hydrophobic filaments 202 collectively form a network that is defined by the shapes and positions of such particles and filaments. The hydrophobic elements of such network may or may not be connected to each other. In FIG. 3, the particles and filaments may either be connected or be merely overlapping with each other within the three-dimensional space of the enclosure 102. The three-dimensional network of particles and filaments, in some examples, may define a plurality of interstitial spaces 302 in which the sorbent elements 104 may be located.

As used herein, the sorbent elements are structured to adsorb and desorb (or capture and release) molecules such as CO₂, such as via direct air capture (DAC), and in some examples also exert hydrophobic force from within the sorbent article in order to expel liquid water from the sorbent article. The sorbent elements may be of any suitable shape, including but not limited to, spherical, polyhedral, or irregular shapes according to the method of how the sorbent elements may be manufactured. In some examples, the sorbent elements are sufficiently soft and flexible so as to facilitate movement of the elements or particles within the casing to facilitate adsorption and desorption (or capture and release) of molecules.

The hydrophobic elements may be made using one or more of expanded polytetrafluoroethylene (ePTFE), polytetrafluoroethylene (PTFE), expanded polyethylene (ePE), another suitable porous polymer, or other material having an appropriate structure. In various embodiments, the hydrophobic elements are made of a flexible porous polymer. It will be appreciated that non-woven materials such as nanospun, meltblown, spunbond, and porous cast films could be among the various other suitable porous polymers. The hydrophobic elements may be expanded by stretching the polymer at a controlled temperature and a controlled stretch rate, causing the polymer to fibrillate. Following expansion, the hydrophobic elements may comprise a structure of a plurality of nodes and a plurality of fibrils that connect adjacent nodes. In these instances, the hydrophobic elements may include pores. Some suitable examples of node-and-fibril structures as defined in this application can be supported by the description provided in U.S. Pat. No. 3,953,566 assigned to W. L. Gore & Associates, Inc. The pores of the hydrophobic elements may be considered micropores. Such micropores may have a single pore size or a distribution of pore sizes. The average pores size may range from approximately 0.1 micron to 100 microns in certain embodiments.

The sorbent material of the sorbent elements may be a substrate having a surface configured to hold the desired substance (e.g., CO₂) from the input on the surface via adsorption. The sorbent elements may vary based on which substances are targeted for adsorption. In various embodiments, the material of the sorbent elements includes a CO₂-adsorbing material which may include, but is not limited to, an ion exchange resin (e.g., a strongly basic anion exchange resin such as Dowex™ Marathon™, a resin available from Dow Chemical Company), zeolite, activated carbon, alumina, metal-organic frameworks, polyethyleneimine (PEI), or another suitable carbon dioxide adsorbing material, such as desiccant, carbon molecular sieve, carbon adsorbent, graphite, activated alumina, molecular sieve, aluminophosphate, silicoaluminophosphate, zeolite adsorbent, ion exchanged zeolite, hydrophilic zeolite, hydrophobic zeolite, modified zeolite, natural zeolites, faujasite, clinoptilolite, mordenite, metal-exchanged silico-aluminophosphate, uni-polar resin, bi-polar resin, aromatic cross-linked polystyrenic matrix, brominated aromatic matrix, methacrylic ester copolymer, graphitic adsorbent, carbon fiber, carbon nanotube, nano-materials, metal salt adsorbent, perchlorate, oxalate, alkaline earth metal particle, ETS, CTS, metal oxide, chemisorbent, amine, organo-metallic reactant, hydrotalcite, silicalite, zeolitic imadazolate framework and metal organic framework (MOF) adsorbent compounds, and combinations thereof.

The sorbent material used in forming the sorbent elements may be present as a coating, a filling, entrained particles, and/or in another suitable form, as described further below. In some examples, the sorbent elements are formed by coating some of the hydrophobic elements with the sorbent material such that the sorbent material forms a substantially continuous coating on the hydrophobic elements such as the nodes and/or fibrils in the network of the structure. It is also within the scope of the present disclosure for at least some of the hydrophobic elements to be filled with the sorbent material such that the sorbent material is incorporated into the nodes and/or fibrils of the structure. In some examples, the hydrophobic elements may be referred to as “powders” due to the small size of each element.

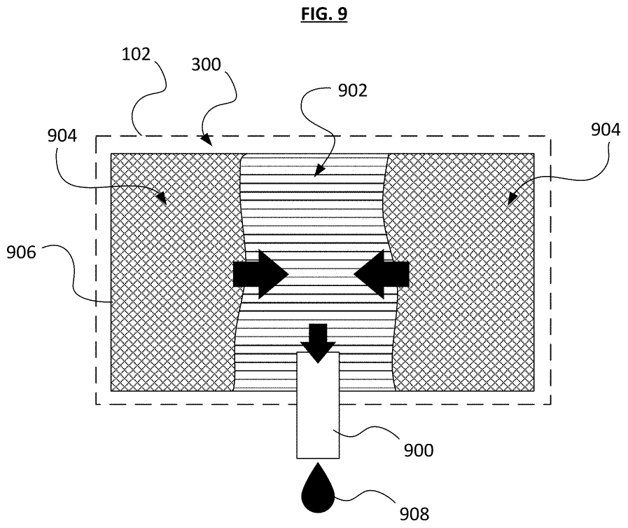

The placement of the hydrophobic elements and sorbent may be random, such as in a homogenous mixture based upon weights of the various components. In some examples, the placement may be precisely engineered (or the sorbent elements and the hydrophobic elements are in a predefined placement with respect to each other) so as to cause hydrophobic forces to be greater in some areas, as shown in FIG. 9. This may allow the hydrophobic forces to cause any liquid water to move in a defined direction (such as toward a drain point). Precise and repeatable placement may be achieved by methods such as used in 3-D printing, wherein nozzles deposit particles in specific amounts to specific areas within a volume.

The fibrils and nodes can be defined in terms of the length-to-width ratio thereof. The length may be defined as the longest dimension of the object being measured, and the width may be defined as the shortest dimension of the object being measured. For example, the fibrils may have a length-to-width ratio that is greater than the length-to-width ratio of the nodes. In some examples, the nodes have a relatively round shape, or a shape with the ratio closer to 1, such as approximately from 1.0 to 1.5, from 1.5 to 2.0, from 2.0 to 2.5, from 2.5 to 3.0, or any other value therebetween or combination thereof. In contrast, the fibrils, in some examples, may have the ratio greater than approximately 10, 20, 30, 40, 50, or any other value or range therebetween, indicating a much more elongated configuration than the nodes.

The sorbent elements 104 and the hydrophobic elements 200 differ from each other in that they have different levels of hydrophobicity; the hydrophobic elements 200 have a first hydrophobicity and the sorbent elements 104 have a second hydrophobicity different from the first hydrophobicity. For example, the sorbent elements 104 may be characterized by a lower hydrophobicity compared to the hydrophobic elements 200. In some examples, the sorbent elements 104 are hydrophilic (that is, non-hydrophobic) or partially/temporarily hydrophobic (parts thereof may have hydrophobicity). The sorbent elements 104 and the hydrophobic elements 200 are shown as separate and disconnected from each other to form the sorbent article 300. In some examples, the elements of the sorbent article 300 may be described as free-floating or mobile with respect to other elements of the article. In some examples, the sorbent elements 104 and the hydrophobic elements 200 weigh differently from each other, such that each hydrophobic element 200 may be heavier or lighter than each sorbent element 104. In some examples, the hydrophobic elements may contribute at least approximately 20% to 30%, 30%, 40%, 50%, 60%, or 70% of a weight of the sorbent article 300, or any other value or increment therebetween. In some examples, the hydrophobic elements may contribute between approximately 20% to 30%, 30% to 40%, 40% to 50%, 50% to 60%, 60% to 70%, or any other value, increment, or combination of ranges thereof, of a density of the sorbent article. The density is defined as the mass of the material (e.g., the hydrophobic elements) divided by the volume occupied by the construct which includes the material (e.g., the sorbent article).

In some examples, the structure (such as the node-and-fibril structure) is at least partially contained within the enclosure 102 and is structured to facilitate restricting the movement of the hydrophobic elements (that is, the hydrophobic elements 200 with respect to the sorbent elements 104 in order to maintain a distribution (such as a mixture or an intermixed distribution) of the sorbent elements 104 and the hydrophobic elements (e.g., 200) The enclosure 102 may be further configured to maintain the sorbent elements 104 and the hydrophobic elements 200 in an intermixed distribution. In some examples, the sorbent elements 104 are discrete and loosely packed within the enclosure 102. In some examples, the hydrophobic elements 200 are also discrete and loosely packed within the enclosure 102.

FIG. 4 illustrates a sorbent material system 400 which includes the sorbent article 300, a first barrier layer 402, and a second barrier layer 404 at least partially surrounding the opposing sides of the sorbent article 300, as well as a water collection tool 406 such as a tank or tube. Sorbent elements 104 are located at least in some of the interstitial spaces 302 within the network of particles 201 and filaments 202. Furthermore, it should also be noted that, even though both barrier layers 402 and 404 are shown, some embodiments may include only one of the layers, that is, either the first barrier layer 402 or the second barrier layer 404. In some examples, there may be additional layer(s) attached or adhered to a surface of one of the first barrier layer 402 and/or the second barrier layer 404.

The first and second barrier layers 402 and 404 are configured to facilitate water vapor to enter (see arrow 408) and exit (see arrow 410) the sorbent article while preventing larger particles such as water droplets from entering the sorbent article 300. That is, the barrier layers 402, 404 may be selectively permeable to water vapor but selectively impermeable to liquid water. This may be facilitated by the hydrophobicity of the barrier layers 402, 404. The barrier layers 402, 404 may be made of any one or more of the aforementioned materials used to form the hydrophobic elements.

The barrier layers 402, 404 may additionally vary in shape. In some embodiments, the barrier layers 402, 404 surrounding the sorbent article 300 may include multiple walls or layers (or sublayers). Additionally, the barrier layers 402, 404 may be flexible and/or collapsible such that it can collapse and expand, thereby allowing for the sorbent article 300 to also collapse and expand. In other embodiments, the barrier layers 402, 404 may be a single-wall structure that spans a length of the sorbent article 300. In summary, the sorbent article 300 comprises a region between the barrier layers 402, 404 wherein adsorption and desorption are capable of occurring. In some embodiments, the sorbent article 300 may be flexible in at least one direction. In particular, the barrier layers 402, 404 may be flexible in at least one direction. This flexibility allows for the sorbent article 300 to collapse into an adsorptive configuration and expand into a desorptive configuration.

The water collection tool 406 may be a tank positioned near the sorbent article 300 which in some examples may at least partially surround the barrier layers 402, 404. The water collection tool 406 gathers the water droplets collected on the surfaces of the barrier layers 402, 404 and reuses and/or disposes the collected water 412, for example.

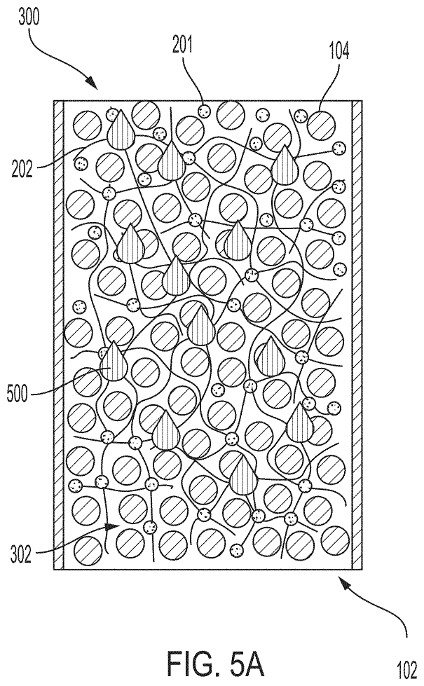

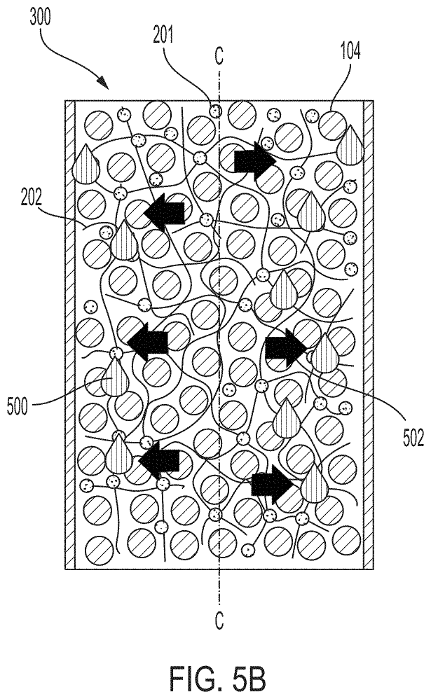

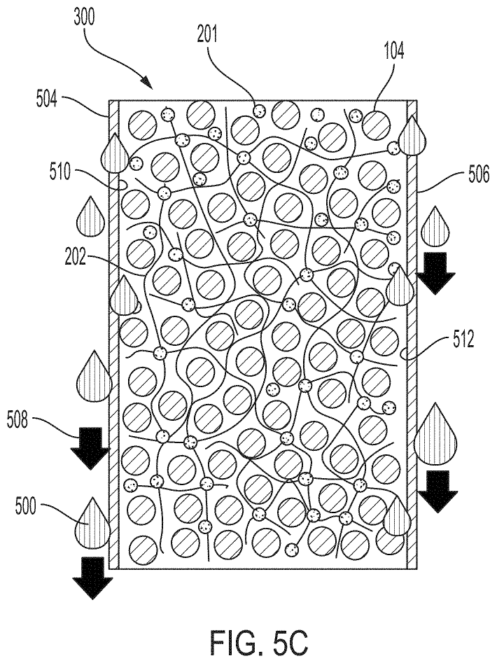

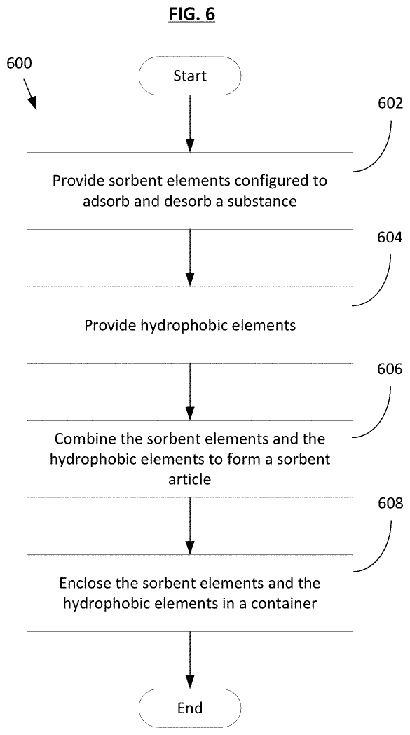

FIGS. 5A through 5C illustrate a water exclusion process facilitated by the sorbent article 300 according to some embodiments. Sorbent elements 104 are located at least in some of the interstitial spaces 302 within the network formed using the hydrophobic particles 201 and the hydrophobic filaments 202.

In FIG. 5A, the water vapor which enters the sorbent article 300 condenses to form liquid water 500, e.g. water droplets or condensation, internally within the sorbent article 300. Liquid water 500 is formed within the interstitial spaces 302 defined by at least some of the hydrophobic particles 201 and hydrophobic filaments 202.

In FIG. 5B, hydrophobic forces 502 exerted by the hydrophobic particles 201 and hydrophobic filaments 202 cause the liquid water 500 to be displaced or moved outwardly away from a center line C-C of the sorbent article 300. The movement of the liquid water 500 may be further facilitated by applying additional external forces such as applying air pressure into the sorbent article 300. In some examples, the movement of liquid water 500 may be facilitated by physically moving or altering the shape of the sorbent article 300 as well.

In FIG. 5C, the liquid water 500 is expelled from the sorbent article 300 via the hydrophobic forces and gather on outer surfaces 504 and 506 (also referred to as exterior surfaces) of the sorbent article 300. Also shown are inner surfaces 510 and 512 (also referred to as interior surfaces) opposing the outer surfaces 504 and 506, respectively, and facing the sorbent article 300. In some examples, the outer surfaces 504, 506 are defined by the enclosure 102 which holds the sorbent article 300 in place. In some examples, the outer surfaces 504, 506 are the external surfaces of the barrier layers 402 and 404, and the inner surfaces 510 and 512 are the internal surfaces of the barrier layers 402 and 404, respectively. The enclosure 102 also includes a portion that perm its passage of CO₂ gas between the external atmosphere and the sorbent article 300, and another portion that permits passage of water (for example, water vapor) between the sorbent article 300 and the outer surfaces 504 and 506. The sorbent article 300 are capable of adsorbing and desorbing the CO₂ gas via the outer surfaces 504 and 506, for example via the application of a temperature change to the sorbent article 300.

The surfaces 504, 506 may have sufficient permeability and hydrophobicity to facilitate liquid water 500 to gather into larger water droplets once outside the sorbent article 300. For example, the hydrophobic forces from within the sorbent article 300 may prevent or reduce the tendency of the liquid water 500 to enter or reenter the sorbent article 300. In some examples, the hydrophobic elements 200 exert sufficient hydrophobic force to expel the liquid water 500 through the barrier layers 402, 404 which may be at least partially hydrophobic. In some embodiments, an internal drain may be provided, for example as shown in the embodiment of FIG. 9, further discussed herein. The hydrophobic forces will cause excess liquid water to move away from the hydrophobic network and toward the path of least resistance, which may be toward the drain.

In some examples, the hydrophobic elements 200 have greater or higher hydrophobicity than the sorbent elements 104 such that the hydrophobic elements 200 within the sorbent article 300 are distributed so as to exert (separately or collectively) a hydrophobic force on any water that is located within the sorbent article 300 when the water transitions from water vapor to liquid water. As such, the hydrophobic force directs liquid water toward the outer surfaces 504 and 506 so as to expel the liquid water from the sorbent article 300.

As more liquid water 500 is gathered, some of the droplets may merge into larger and heavier water droplets as shown via cohesion. As the size and weight of the water droplets increase, the droplets fall downward as gravitational force 508 overpowers the surface adhesion. The fallen droplets may then be gathered in the water collection tool 406 as previously described.

FIG. 6 shows a flowchart of a process 600 of making the sorbent article according to embodiments as disclosed herein. In step 602, the plurality of sorbent elements configured to adsorb and desorb a substance are provided. In step 604, the plurality of hydrophobic elements are provided. In step 606, the sorbent elements and the hydrophobic elements are combined to form the sorbent article. The combining may be performed using any suitable method such as mixing, blending, stirring, etc. The combining may be performed to achieve an even level of mixture or intermixed distribution throughout the sorbent article, or it may be performed only in some portions of the sorbent article. As mentioned previously, the hydrophobic network and sorbent may be placed with specific relation to each other. In some examples, the intermixed distribution is defined by a state of disorder or randomness (i.e., uneven distribution) with respect to the internal distribution of the sorbent and hydrophobic elements within the sorbent article.

In some embodiments, there is a further step 608 in which the sorbent elements and the hydrophobic elements are enclosed within a container which maintains the intermixed distribution of the sorbent and hydrophobic elements with respect to each other. In some embodiments, instead of the container, the sorbent elements and the hydrophobic elements may be disposed between two barrier layers, where the layers are at least partially hydrophobic. The hydrophobic barrier layers may have a first permeability with respect to water vapor that is greater than a second permeability with respect to liquid water. Liquid water may be formed as result of condensation of the water vapor within the sorbent article. In some examples, the second permeability is defined such that the hydrophobic layer is impermeable with respect to the liquid water under atmospheric pressure.

In some embodiments, there may be an additional step where, if the plurality of hydrophobic elements are a first plurality of hydrophobic elements having a first hydrophobicity, a second plurality of hydrophobic elements may be combined with the sorbent elements and the first plurality of hydrophobic elements. The second plurality of hydrophobic elements may have a material different from the first plurality of hydrophobic elements, and the material of the second plurality of hydrophobic elements may be characterized by a second hydrophobicity that is different from the first hydrophobicity of the first plurality of hydrophobic elements. Furthermore, the second plurality of hydrophobic elements may be combined with the sorbent elements and the first plurality of hydrophobic elements such that the hydrophobic elements are disposed within the spaces defined by the network of hydrophobic elements. In some examples, the second plurality of hydrophobic elements may be disposed within the interstitial spaces defined by the network of hydrophobic elements. In some examples, the second plurality of hydrophobic elements may be added in order to increase the hydrophobic force exerted from the combination of the first and second pluralities of hydrophobic elements. In some examples, a drain may be formed, such as in or through the material defining the container, such that the liquid water may be expelled from the container through the drain. The water collection tool may also be attached to or positioned proximal to the container to collect the expelled liquid water.

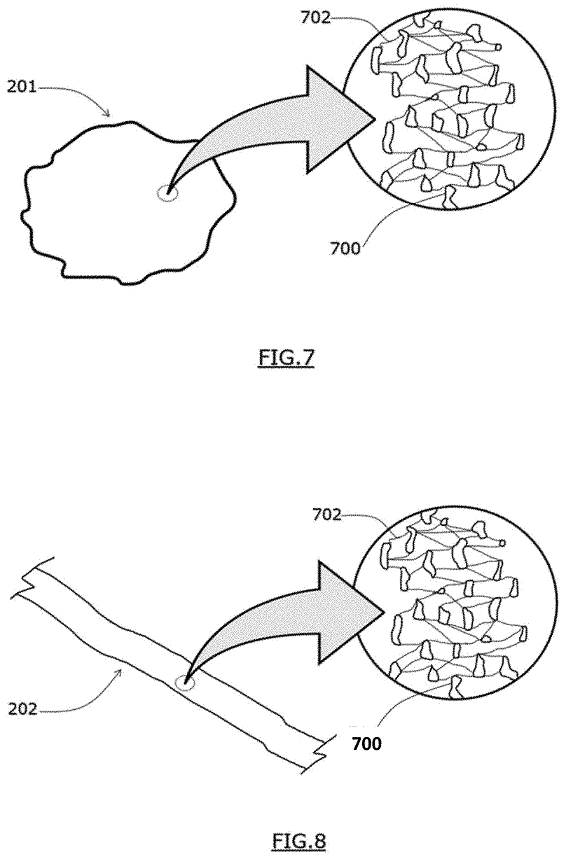

FIG. 7 shows an embodiment of the hydrophobic particle 201 according to examples disclosed herein. In some examples, the hydrophobic particle 201 may include one or more nodes 700 as well as one or more fibrils 702 which form the shape and configuration of the hydrophobic particle 201. The nodes 700 may be interconnected via the fibrils 702 (that is, fibrils 702 which are smaller than the filaments 202 of FIGS. 2 and 3, for example) to form a network of interconnected nodes and fibrils, where the nodes and fibrils may be attached or fixedly connected with respect to each other to form the particle 201. The network may be a three-dimensional network such that the particle 201 as formed may assume a three-dimensional shape such as a sphere, polyhedron, or any other suitable shape or configuration. Therefore, the particle 201 may be comprised of nodes 700 and fibrils 702.

FIG. 8 shows an embodiment of the filament 202 according to examples disclosed herein. In some examples, the filament 202 may include one or more nodes 700 as well as one or more fibrils 702 which form the shape and configuration of the filament 202. The fibrils 702 may connect the nodes 700 together to form the filament 202. Therefore, filament 202 may be comprised of nodes 700 and fibrils 702.

To clarify further, hydrophobic filaments 202 and hydrophobic particles 201 may be formed of a 3-dimensional network of nodes 700 and fibrils 702. There exists a hierarchical arrangement in which the particles 201 and filaments 202 are larger than the fibrils 702 and nodes 700. Nodes 700 and fibrils 702 may be connected and can provide interstitial space for which the sorbent elements 104 may be housed. In turn, the larger order particles 201 and filaments 202 may also form a next-order, (larger) 3-dimensional network which also provides interstitial space for which more of the sorbent elements 104 may be placed.

FIG. 9 shows an embodiment of the sorbent article 300 according to examples of the present disclosure. The sorbent article 300, in some examples, may be stored or at least partially confined within the enclosure 102 such as a casing or other type of container, where the enclosure 102 may also include a drain 900 which is a conduit extending through the enclosure 102 connecting the inside of the enclosure with the outside. In some examples, the enclosure 102 is defined or formed by an exterior surface 906 of the sorbent article 300 instead of being a separate component of its own, in which case the drain 900 may extend through the exterior surface 906 of the sorbent article 300 to reach the internal mixture which defines the sorbent article 300. The internal mixture may contain discrete and loosely packed sorbent elements as well as discrete and loosely packed hydrophobic elements, as disclosed herein.

In some examples, the portion of the enclosure 102 which permits passage of CO₂ gas between the external atmosphere and the sorbent article 300 is formed by the exterior surface 906 of the sorbent article 300. In some examples, the portion of the enclosure 102 which permits passage of water between the sorbent article 300 and the outer surfaces 504 and 506 is formed by the exterior surface 906 of the sorbent article 300. The sorbent article 300 is arranged such that there is an area or region 902 of lower hydrophobicity surrounded by areas or regions 904 of higher hydrophobicity.

As shown by the centrally-pointing arrows, the hydrophobic forces from the regions 904 where greater hydrophobicity exists push any water droplet which may form within the sorbent article 300 (that is, liquid water formed as a result of condensation of any water vapor which remained within the sorbent article 300) toward the region 902 therebetween where the hydrophobicity is lower (which, in some examples, may even be hydrophilic). The water droplets collected within the region 902 are pulled downward by gravitational force, as shown by the downward-pointing arrow, and subsequently purged or expelled from the inside of the enclosure 102 through the drain 900. Expelled water 908, in some examples, may be collected using the water collection tool 406 as previously discussed.

The features and properties of the sorbent article as disclosed herein facilitate efficient and effective water exclusion from within the sorbent article. Advantages in facilitating such water exclusion include the ability to maintain the sorbent article dry or relatively dry. In the process of capturing CO₂, the sorbent article may receive water internally within the sorbent article in the form of steam. Evaporation of water vapor from the steam may lower the internal temperature of the sorbent article and facilitate the CO₂ capturing process. However, not all of the water vapor may completely evaporate, so a portion of the water vapor may remain inside the sorbent article (e.g., as water droplets or condensation). In some scenarios, a presence of condensation within the sorbent article may reduce the efficiency of CO₂ capturing capability of the sorbent article, that is, the presence of increased moisture within the sorbent article may reduce CO₂ capturing capability. In some scenarios, the presence of water may cause the sorbent (e.g., potassium carbonate) to be dissolved and/or reduce the kinetics of the system by lengthening the dry cycles. Furthermore, in some scenarios, liquid water may increase the rate of oxidation in some polymers. As such, it may be preferable to remove as much of the condensation or other moisture from the sorbent article as possible to keep the sorbent article relatively dry during the CO₂ capturing (adsorption) phase as compared to the CO₂ release (desorption) phase.

The sorbent article 300 shown in FIGS. 3, 4, and 5 provide examples of the various features of the sorbent article and, although the combination of those illustrated features is clearly within the scope of disclosure, these examples and their illustration are not meant to suggest the inventive concepts provided herein are limited from fewer features, additional features, or alternative features to one or more of those features shown in these figures, or in other figures. For example, in various embodiments, the sorbent article shown in FIG. 3 may include the barrier layers 402, 404 described with reference to FIG. 4. It should also be understood that the reverse is true as well. One or more of the components depicted in FIG. 4 can be employed in addition to, or as an alternative to components depicted in FIG. 3, and vice versa.

The disclosure of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this disclosure provided they come within the scope of the appended claims and their equivalents.

What is claimed is:

1. A sorbent article comprising:
a plurality of sorbent elements structured to adsorb and desorb CO₂; and
a plurality of hydrophobic elements mixed with the plurality of sorbent elements and structured to exert hydrophobic force to expel liquid water from the sorbent article.

2. The sorbent article of claim 1, further comprising:
a container in which the plurality of sorbent elements and the plurality of hydrophobic elements are maintained in an intermixed distribution.

3. The sorbent article of claim 2, the container comprising a drain through which the liquid water is expelled from the sorbent article.

4. The sorbent article of claim 2, wherein the sorbent elements are discrete and loosely packed within the container, and the hydrophobic elements are discrete and loosely packed within the container.

5. The sorbent article of claim 2, wherein the hydrophobic elements form a network of hydrophobic elements.

6. The sorbent article of claim 5, wherein the network of hydrophobic elements defines a plurality of interstitial spaces within the network of hydrophobic elements and at least some of the sorbent elements are disposed within the interstitial spaces defined by the network of hydrophobic elements.

7. The sorbent article of claim 5, wherein the network of hydrophobic elements is entrained in a structure having a plurality of hydrophobic nodes and fibrils.

8. The sorbent article of claim 7, wherein the structure is at least partially contained within the container and is structured to facilitate restricting movement of the hydrophobic elements with respect to the sorbent elements to maintain the intermixed distribution of the plurality of sorbent elements and the plurality of hydrophobic elements.

9. The sorbent article of claim 1, further comprising at least one hydrophobic layer disposed adjacent to the sorbent elements and the hydrophobic elements.

10. The sorbent article of claim 9, comprising two porous hydrophobic layers such that the sorbent elements and the hydrophobic elements are disposed between the two porous hydrophobic layers.

11. The sorbent article of claim 8, wherein the hydrophobic layer has a first permeability with respect to water vapor that is greater than a second permeability with respect to liquid water, wherein the liquid water is formed as result of condensation of the water vapor within the sorbent article.

12. The sorbent article of claim 11, wherein the second permeability is defined such that the hydrophobic layer is impermeable with respect to the liquid water under atmospheric pressure.

13. The sorbent article of claim 9, wherein the hydrophobic elements are configured to exert sufficient hydrophobic force to expel the liquid water through the hydrophobic layer.

14. The sorbent article of claim 1, wherein the hydrophobic elements are configured to exert the hydrophobic force against liquid water located on a surface of the sorbent article to facilitate reducing an amount of liquid water entering the sorbent article.

15. The sorbent article of claim 6, wherein the hydrophobic elements are a first plurality of hydrophobic elements having a first hydrophobicity, the sorbent article further comprising a second plurality of hydrophobic elements of a material different from the first plurality of hydrophobic elements characterized by a second hydrophobicity that is different from the first hydrophobicity.

16. The sorbent article of claim 15, wherein the second plurality of hydrophobic elements are different in size or shape from the first plurality of hydrophobic elements.

17. The sorbent article of claim 15, wherein the second plurality of hydrophobic elements are disposed within the interstitial spaces defined by the network of hydrophobic elements.

18. The sorbent article of claim 1, wherein the plurality of hydrophobic elements contribute to between approximately 30% and 70% of a density of the sorbent article.

19. A method of forming a sorbent article, the method comprising:
providing a plurality of sorbent elements configured to adsorb and desorb a substance;
providing a plurality of hydrophobic elements; and
combining the sorbent elements and the hydrophobic elements to form a sorbent article such that the hydrophobic elements are configured to exert hydrophobic force to expel liquid water from the sorbent article.

20. The method of claim 19, further comprising:
enclosing the plurality of sorbent elements and the plurality of hydrophobic elements in a container such that the sorbent elements and the hydrophobic elements are maintained in an intermixed distribution.

21. The method of claim 20, wherein the container is structured to facilitate restricting movement of the hydrophobic elements with respect to the sorbent elements to maintain the intermixed distribution thereof.

22. The method of claim 19, wherein the hydrophobic elements form a network of hydrophobic elements.

23. The method of claim 22, wherein the network of hydrophobic elements defines a plurality of interstitial spaces within the network of hydrophobic elements, the method further comprising:
combining the sorbent elements and the hydrophobic elements such that the sorbent elements are disposed within the interstitial spaces defined by the network of hydrophobic elements.

24. The method of claim 19, further comprising:
disposing at least one porous hydrophobic layer adjacent to the sorbent elements and the hydrophobic elements.

25. The method of claim 23, wherein the plurality of hydrophobic elements are a first plurality of hydrophobic elements having a first hydrophobicity, the method further comprising:
combining a second plurality of hydrophobic elements with the sorbent elements and the first plurality of hydrophobic elements, the second plurality of hydrophobic elements having a material different from the first plurality of hydrophobic elements characterized by a second hydrophobicity that is different from the first hydrophobicity.

26. The method of claim 25, wherein the second plurality of hydrophobic elements are combined with the sorbent elements and the first plurality of hydrophobic elements such that the hydrophobic elements are disposed within the spaces defined by the network of hydrophobic elements.

27. The method of claim 19, further comprising forming a drain through which the liquid water is expelled from the container.

28. The method of claim 19, wherein combining the sorbent elements and the hydrophobic elements to form the sorbent article comprises: disposing the sorbent elements and the hydrophobic elements in a predefined placement with respect to each other via 3-D printing.

29. A sorbent article for removing carbon dioxide gas from an atmosphere, the sorbent article comprising:
an enclosure supporting a distribution of sorbent elements intermixed with hydrophobic elements, the enclosure defining an exterior surface of the enclosure and an opposing interior surface facing the distribution, a first portion of the enclosure permitting passage of the carbon dioxide gas between the atmosphere and the distribution, a second portion of the enclosure permitting passage of a mass of water between the distribution and the exterior surface of the enclosure,
wherein the sorbent elements are capable of adsorbing and desorbing the carbon dioxide gas via the exterior surface of the enclosure with the application of a temperature change to the distribution,
wherein the hydrophobic elements define a first hydrophobicity of the hydrophobic elements and the sorbent elements define a second hydrophobicity of the sorbent elements, the second hydrophobicity being lesser than the first hydrophobicity,
wherein the hydrophobic elements within the distribution are distributed to exert a hydrophobic force on the mass of water within the distribution when the mass of water transitions to a liquid water, the hydrophobic force directing the liquid water to the exterior surface of the enclosure to expel the liquid water from the distribution.

30. The sorbent article of claim 29, wherein the hydrophobic elements define a structure having a plurality of hydrophobic filaments, the plurality of hydrophobic filaments forming a network defining a plurality of interstitial spaces between the plurality of hydrophobic filaments.

31. The sorbent article of claim 30, wherein the sorbent elements are disposed within the interstitial spaces.

32. The sorbent article of claim 29, wherein the enclosure is formed by an exterior surface of the distribution.

33. The sorbent article of claim 29, wherein the first portion of the enclosure is formed by an exterior surface of the distribution.

34. The sorbent article of claim 29, wherein the second portion of the enclosure is formed by an exterior surface of the distribution.

35. The sorbent article of claim 29, wherein the enclosure defines a drain through which the liquid water is expelled from the distribution.

36. The sorbent article of claim 29, wherein the sorbent elements are discrete and loosely packed within the enclosure, and the hydrophobic elements are discrete and loosely packed within the enclosure.

37. The sorbent article of claim 29, wherein the hydrophobic elements are composed of at least one of expanded polytetrafluoroethylene (ePTFE), polytetrafluoroethylene (PTFE), or expanded polyethylene (ePE).
